(19) United States
(12) Patent Application Publication
(10) Pub. No.: US 2015/0011301 A1
(43) Pub. Date: Jan. 8, 2015

(54) AWARDING GAMING CREDITS FOR GAME PLAY BEFORE AWARDING A CASH PAYOUT

(71) Applicant: New BIS Safe Luxco S.á r.l., Luxembourg (LU)

(72) Inventor: Andrew John Cardno, San Diego, CA (US)

(21) Appl. No.: 14/317,256

(22) Filed: Jun. 27, 2014

Related U.S. Application Data
(60) Provisional application No. 61/842,058, filed on Jul. 2, 2013.

(51) Int. Cl. G07F 17/32

(52) U.S. Cl. CPC G07F 17/3244
USPC 463/25

(57) ABSTRACT

A gaming system obtains wagers from players for game play. Winnings from game play are first awarded as gaming credits for additional game play. Then, winnings from the additional game play using the gaming credits are paid out to the player at cash value.

### CROSS REFERENCE TO RELATED APPLICATION

This application claims the benefit of U.S. Provisional Application No. 61/842,058, filed 2 Jul. 2013 and which application is hereby incorporated by reference in its entirety. To the extent appropriate, a claim of priority is made to the above disclosed application.

### BACKGROUND

Gaming casinos provide a variety of different games that can be played. Several examples of such games include table games such as blackjack and roulette, slot machines, and video games such as video poker.

Although the result of playing any particular game is typically largely random, casino games are often designed so that the amount of money returned to players over time is a percentage of the amount of money gambled. In general, players are more likely to enjoy playing games that return a greater amount of money to the players over time.

In some areas, the returns from casino games are regulated so that the amount of money returned to the players over time must actually be below a defined threshold. A low return rate may be discouraging to players resulting in frequent losses, or smaller winnings than desired.

### SUMMARY

In general terms, this disclosure is directed to games of chance involving wagers. In one possible configuration and by non-limiting example, the disclosure relates to awarding gaming credits for game play before awarding a cash payout. Various aspects are described in this disclosure, which include, but are not limited to, the following aspects.

One aspect is a method of game play, the method comprising: playing a first game on one or more gaming devices; awarding winnings from the first game as gaming credits; playing a second game on the one or more gaming devices using the gaming credits; and paying out winnings from the second game.

Another aspect is a gaming system comprising: at least one gaming device; and an accounting system including at least one computing device, wherein the accounting system manages player accounts, the player accounts including a cash account and a gaming credits account, wherein the accounting system is operable to: when the player wins a game on the at least one gaming device on a wager from the cash account, award the winnings as gaming credits in the gaming credits account; and when the player wins a game on the at least one gaming device on a wager from the gaming credits account, award the winnings as cash in the cash account.

A further aspect is a method of game play comprising: awarding winnings of a first stage of game play as gaming credits using a computing device; using the gaming credits as a wager for a second stage of game play; and awarding winnings of the second stage of game play to the player as a cash value using the computing device.

### BRIEF DESCRIPTION OF THE DRAWINGS

FIG. 1 is a schematic flow chart illustrating an example method of game play.

FIG. 2 is a schematic diagram illustrating another example method of game play.

FIG. 3 is a schematic diagram illustrating another example method of game play.

FIG. 4 is a schematic block diagram illustrating an example gaming system.

FIG. 5 is a schematic block diagram illustrating an example of player accounts managed by an accounting system of the gaming system shown in FIG. 4.

FIG. 6 is a schematic block diagram illustrating another example of the player accounts managed by the accounting system shown in FIG. 4.

FIG. 7 is a diagram illustrating an example of game play according to the present disclosure.

FIG. 8 is another diagram illustrating an example of game play according to the present disclosure.

FIG. 9 illustrates an exemplary architecture of a computing device that can be used to implement aspects of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

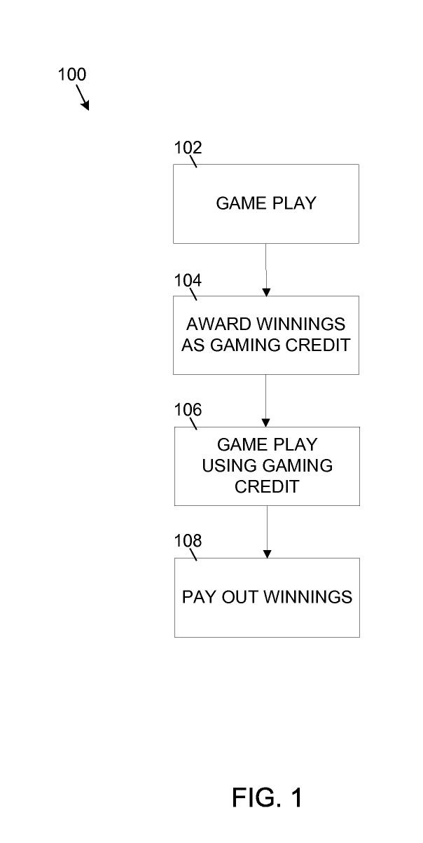

FIG. 1 is schematic flow chart illustrating an example method 100 of game play. In this example, the method includes operations 102, 104, 106, and 108.

The game is played in operation 102. In some embodiments, the game is a casino game. Examples of casino games include electronic games and table games. Several common examples of electronic games include slot machines and video poker games. An example of a table game is roulette. All casino games are typically part of an electronic gaming system, discussed in more detail herein, which manages various aspects of game play, such as managing player accounts.

The game play in operation 102 typically involves a wager having a certain value. For example, a cash value wager can be made. A cash value is, for example, the amount of money that the player is offering as the wager. As another example, it is not uncommon for casinos to offer free play credits to players. The free play credits may be offered as a reward for loyal patronage, or can be awarded as an incentive to bring in new players, for example. Free play credits typically have no cash value (i.e., they are given to the player for free), but have a free play value which permits the player to play the game (operation 102) just as if the free play value were a cash value.

The game play in operation 102 typically involves a set of rules, and the player is awarded a prize if a set of conditions is met according to the rules.

When the player wins the game play in operation 102, the winnings are awarded as gaming credit. In some embodiments, the gaming credit is credit that can be used by the player for subsequent game play. In some embodiments, the gaming credit is non-redeemable. In some embodiments gaming credits have no cash value. In other embodiments, the gaming credits are redeemable, but have a cash value of less than the gaming credits value.

The player does not always win game play in operation 102, and therefore in some embodiments operation 104 is only performed to award winnings as gaming credit when the player has won the game play.

After winning gaming credits in operation 104, operation 106 is performed to play the game using the gaming credits. For example, a wager is made by the player using the gaming credits. The value of the wager, in this example, is the gaming credit value.

Operation 108 is performed to pay out winnings when the player wins the game play in operation 106. In this example, the winnings are paid out in cash having a cash value. Therefore, in some embodiments the winnings are cash (e.g., dollar bills or coin currency paid directly by the game) or have a cash value (e.g., paid in chips having a cash value or by a credit to the player's account in the amount of the cash value).

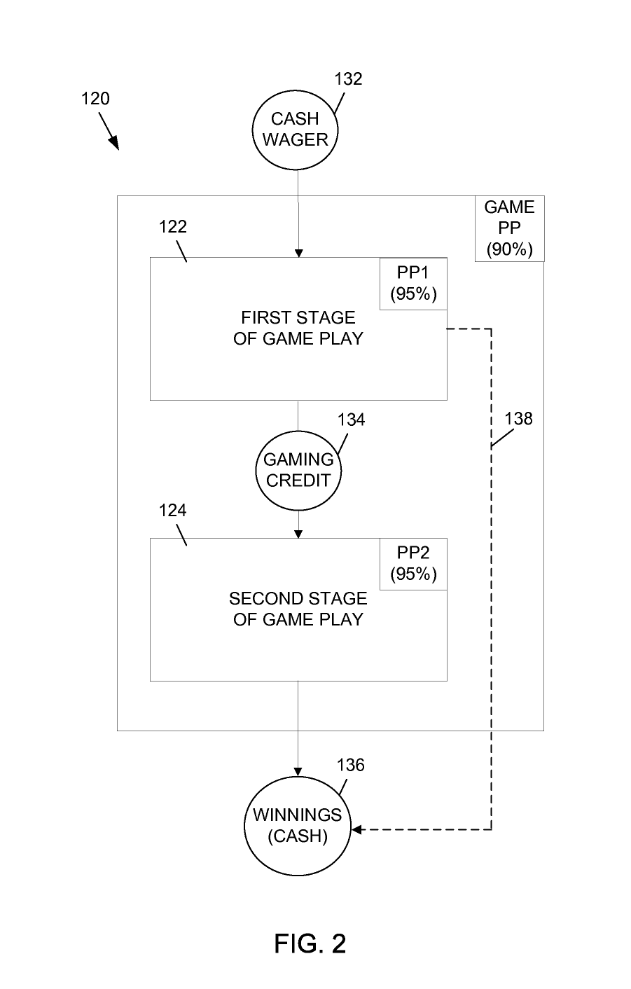

FIG. 2 is a schematic diagram illustrating another example method 120 of game play. In this example, the method 120 includes a first stage 122 of game play and a second stage 124 of game play. The diagram also illustrates exemplary payout percentages (“PP”), including a first payout percentage (PP1), a second payout percentage (PP2), and an overall game payout percentage (Game PP). Also shown are a cash wager 132, gaming credits 134, and winnings 136.

An important characteristic of a game is the game's payout percentage. As discussed in further detail below, the payout percentage is the expected percentage of the wagers received by a game that the game will return to the players over time in the form of winnings As one example, the game illustrated in FIG. 2 has an overall game payout percentage (Game PP), which may be 90%, for example. The difference between the amount returned to the players over time (e.g., 90%) and the total amount wagered (100%) is the hold percentage (e.g., 100%−90%=10%), and is the basis on which the gaming device generates revenues.

Although a lower payout percentage may increase the hold percentage, and thereby increase the revenues derived from a single play of a game, a game having a lower payout percentage may be discouraging to players and dull to play. A game having a higher payout percentage can be more exciting to players, due to the more frequent or higher winnings that are provided by the game.

The example shown in FIG. 2 illustrates a method 120 of game play in which a lower game payout percentage (Game PP, such as 90%) can be established, while providing individual stages 122 and 124 of game play that have higher payout percentages (PP1and PP2, such as 95% respectively). This can lead to a more exciting game to play, while still maintaining an adequate overall game payout percentage (Game PP).

The first stage 122 of game play involves receiving a cash wager 132 from a player. In some embodiments the cash wager 132 is cash, such as a coin or paper currency, that is provided by the player to the gaming device. In other embodiments, the cash wager 132 has a cash value, but is made physically or electronically in another manner, such as by presenting one or more poker chips having a cash value, through a credit card transaction, using a printed receipt indicating a cash value, a selection made through an input device through the gaming device, and the like. In another possible embodiment, the cash wager 132 may alternatively be gaming credit, such as free play credits.

The game is then played, and a result is determined. Typically, the result includes a determination of whether the player has won or lost based on the rules of the game. If the player has lost, then the player typically forfeits the cash value. For example, the gaming machine, dealer, and/or casino receive the cash value. Once again, the transaction can be completed through a transfer of currency or chips, an electronic transfer, or in another manner.

On the other hand, if the player wins, the rules of the game determine the amount that the player wins. In this example, the amount of the winnings is awarded to the player in the form of gaming credit 134. In some embodiments, a player's balance of gaming credits is managed by an accounting system, as discussed in further detail herein. In another embodiment, the gaming credits can be managed by the gaming device itself, or by a dealer, for example.

Although the particular result of the first stage 122 of game play typically has at least some element of chance or randomization resulting in the player sometimes winning and sometimes losing during game play, the first stage 122 of game play is also typically controlled so that over time the first stage 122 of game play will return a certain percentage of the cash wager 132 to the players (in the form of gaming credit 134, in this example). This percentage is referred to as the payout percentage (PP1). As one example of a payout percentage, the first stage 122 of game play may have a payout percentage (PP1) of 95%. This means that over time, the first stage 122 of game play is expected to return 95% of the cash wager 132 to the players as winnings

Once the player has obtained gaming credits 134, the player can then use the gaming credits in the second stage 124 of game play.

The second stage 124 of game play involves receiving a wager of gaming credits 134. In some embodiments, the second stage 124 cannot be played with a cash wager 132, and must be played with the gaming credits 134.

The second stage 124 is then played, and a result is determined based on the rules of the game. If the player loses, the gaming credits 134 are deducted from the player's gaming credit balance or otherwise made so that they are no longer available for game play. If the player wins, the gaming credits 134 are still deduced from the player's gaming credit balance, but the winnings 136 are awarded to the player. In some embodiments the winnings 136 are cash or have a cash value.

As with the first stage 122 of game play, the second stage 124 of game play is also controlled so that over time the second stage 124 of game play will return a certain percentage of the gaming credit 134 wager to the player as winnings 136. An example of this payout percentage (PP2) is 95%, which means that over time the second stage of game play is expected to return 95% of the gaming credit to the players in the form of winnings 136. In other embodiments, the payout percentage (PP2) of the second stage 124 is different from the payout percentage (PP1) of the first stage 122.

In this example, the overall game payout percentage can be calculated as the product of the payout percentage (PP1) of the first stage 122 and the payout percentage (PP2) of the second stage using Equation 1.

Game PP=PP1*PP2 Equation 1

Using the example percentages provided above, the overall game payout percentage (Game PPP) is computed as 0.95×0.95=about 90%.

Therefore, in this example, first and second stages 122 and 124 of game play provide a higher payout percentage (e.g., 95%), thereby increasing the excitement of game play, while providing an overall game payout percentage that is lower (e.g., 90%).

Equation 1 can be used to set the first and second stage payout percentages (PP1 and PP2) to achieve a desired game payout percentage (Game PP), or conversely can be used to set the game payout percentage (Game PP) to achieve desired first and second stage payout percentages (PP1 and PP2).

Another possible embodiment of the method 120 is also illustrated in FIG. 2, which further includes the alternate flow path 138. In this example, winning the first stage 122 of game play can result in either an award of gaming credit 134, as discussed above, or can alternatively result in the payout of cash winnings 136 through alternate flow path 138. As one example, the flow path 138 occurs when the result of the first stage of game play is a jackpot. In another example, the flow path 138 occurs when the winnings exceed a predetermined threshold value.

In some situations it may be preferred to permit a player to immediately cash out (136) winnings from the first stage 122 of game play, rather than awarding the winnings as gaming credit 134. As one example, if the player wins a large jackpot during the first stage 122 of game play, the winnings are awarded as cash winnings 136. One reason that this may be preferred is that often when a player wins a large sum of money, the player will choose to stop playing at that point and want to cash out the winnings By allowing the player to immediately cash out winnings 136, the player is permitted to do this, and is not inconvenienced to have to continue playing the entire jackpot through the second stage 124 before it can be cashed out as winnings 136. Additionally, in some cases it may also be undesirable to the casino to have the player continue playing the entire jackpot through the second stage 124, because it could result in even greater winnings.

Therefore, in some embodiments one or more awards from a game (e.g., certain lines in a game's pay table, or based on an award that exceeds a threshold value) are set to pay out all winnings as cash winnings 136, regardless of whether the game is being played with a cash wager 132 in the first stage 122 of game play or gaming credits in the second stage 124 of game play.

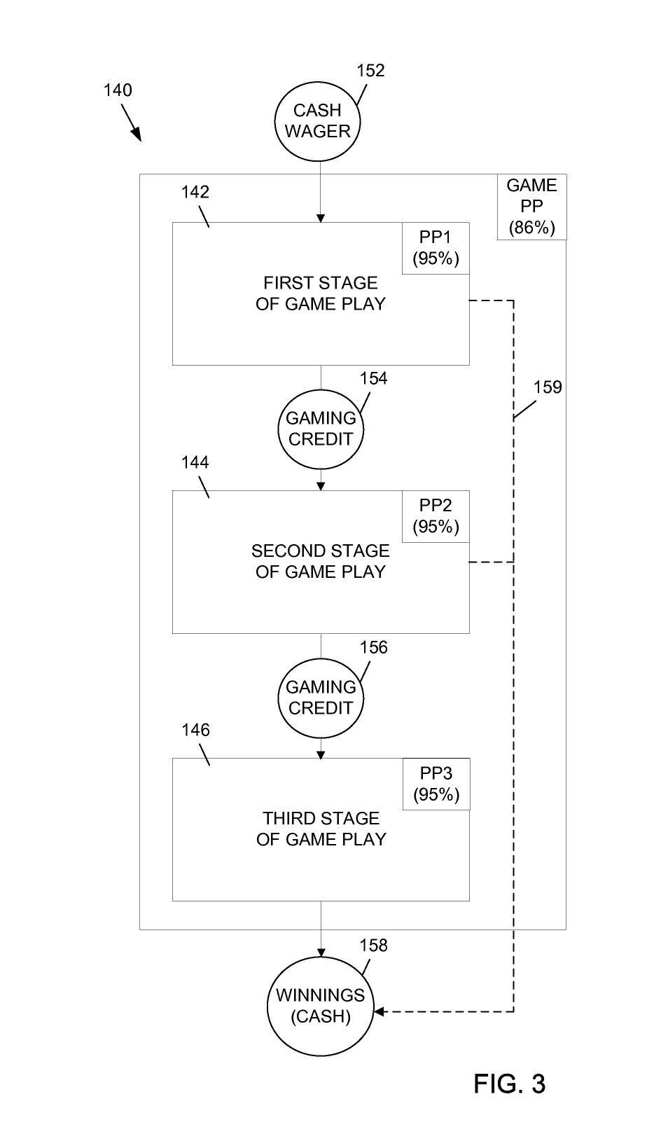

FIG. 3 is a schematic diagram illustrating another example method 140 of game play. In this example, the method 140 includes a first stage 142 of game play, a second stage 144 of game play, and a third stage 146 of game play. The diagram also illustrates exemplary payout percentages (“PP”), including a first payout percentage (PP1), a second payout percentage (PP2), a third payout percentage (PP3) and an overall game payout percentage (Game PP). Also shown are a cash wager 152, gaming credits 154, gaming credits 156, and winnings 158.

This example is similar to the example shown in FIG. 2, but illustrates how additional stages, such as a third stage 146, can be added to provided additional flexibility in the payout percentages.

As in the prior example, a cash wager 152 is received from the player, a first stage 142 of game play is performed, and gaming credits 154 are awarded 154 if the player is determined to have won the first stage 142 of game play.

The gaming credits 154 are then used as a wager for the second stage 144 of game play. In this example, any winnings that result from the second stage of game play are again awarded to the player in the form of gaming credits 156.

The gaming credits 156 are then used as a wager for the third stage 146 of game play. Upon conclusion of the third stage of game play, any winnings that result are awarded to the player as winnings 158, in the form of cash or having a cash value.

In this example, the overall game payout percentage (Game PP) can be computed using Equation 2.

Game PP=PP1*PP2*PP3 Equation 2

If the individual stage payout percentages PP1, PP2, and PP3 are the same as in the prior example (95%), then the overall game payout percentage (PP) can be computed as 0.95×0.95×0.95=about 86%.

This shows that without changing the payout percentages of the individual stages, the overall game payout percentage can be even further reduced by the inclusion of an additional stage 146 in the game. Conversely, without adjusting the overall game payout percentage, the individual stage payout percentages can be increased by the inclusion of an additional stage 146 in the game. Additional stages (e.g., four, five, six, etc.) can also be added to form yet other embodiments in the same manner.

In some embodiments the individual stage payout percentages PP1, PP2, and PP3 are not the same. For example, in one embodiment the payout percentages increase, such as a lower payout percentage on the first stage, to a higher payout percentage in the second stage 144, and yet a higher payout percentage in the third stage 146. In another embodiment, the payout percentages decrease, such as from the highest payout percentage in the first stage 142 to the lowest payout percentage in the third stage 146. Other payout percentages are used in other embodiments.

As similarly discussed above with reference to FIG. 2, another possible embodiment of method 140 includes a flow path 159 in which certain winnings of the first and second stages 142 and 144 of game play are paid out directly as cash winnings 158. This can occur, for example, for large prizes such as the jackpot or for the largest one, two, three, or more prizes awarded by the game (e.g., such as defined by the pay table of the game).

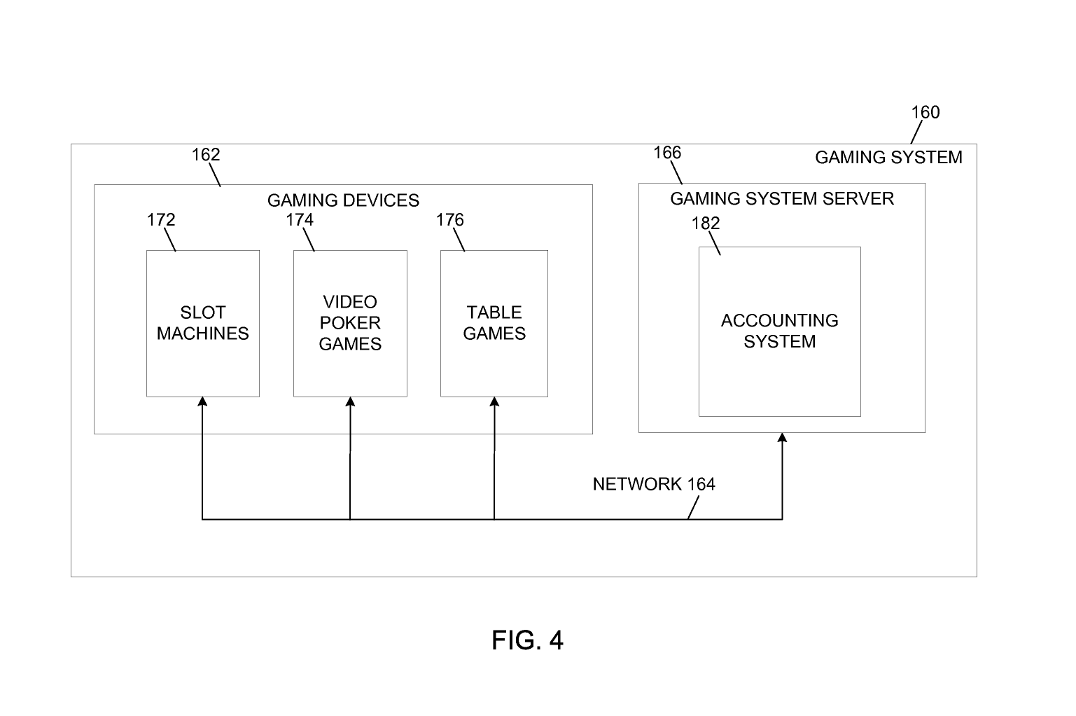

FIG. 4 is a schematic block diagram illustrating an example gaming system 160. In this example, the gaming system 160 includes gaming devices 162, network 164, and gaming system server 166.

In some embodiments, the gaming system 160 is at a gaming site, such as a casino. However, in some embodiments one or more aspects of the gaming system 160 can be located remote from the gaming site. For example, the gaming system server 166 can be remote from the gaming devices 162 in some embodiments.

A player interacts with the gaming devices 162 in order to play one or more games. Several examples of gaming devices include slot machines 172, video poker games 174, and table games 176. Other embodiments can include other games as well, such as any of a variety of casino or online games that involve betting and have payout percentages that can be controlled.

The slot machine 172 typically includes a computing device including a display, a processing device, a computer-readable storage device, a network communication device, and input controls. The input controls may include a lever, and typically include at least several buttons to permit the selection of a wager value and initiation of game play. Various types of slot machines can be used, having a variety of different rules for game play. Commonly the slot machine includes three columns (or reels) in which symbols appear to spin until they come to a stop. The player wins if the symbols stop in one or more predetermined arrangements, such as three of the same symbol arranged in a line.

The video poker games 174 typically include a computing device including a display, a processing device, a computer-readable storage device, a network communication device, and input controls. The input controls are used to place a wager and to provide other inputs utilized during game play. Various poker games can be played on video poker games 174.

Table games 176 typically include a physical table on which a game is played. An example of a table game 176 is a roulette table. A dealer often overseas game play at each of the table games 176. In addition to the table, some embodiments further include a computing device or other electronic device(s) that is used to track game play and check and adjust player accounts. Therefore, in some embodiments the table games 176 also include a computing device, such as including a processing device, a computer-readable storage device, a network communication device, and input controls.

In some embodiments the gaming devices 162 are connected to a data communication network 164. The network can include multiple different communication networks in some embodiments. An example of a network 164 is a local area network. The network 164 can include wireless and/or wired communication systems. The network is also connected to the gaming system server 166 to permit data communication between the gaming device 162 and the gaming system server.

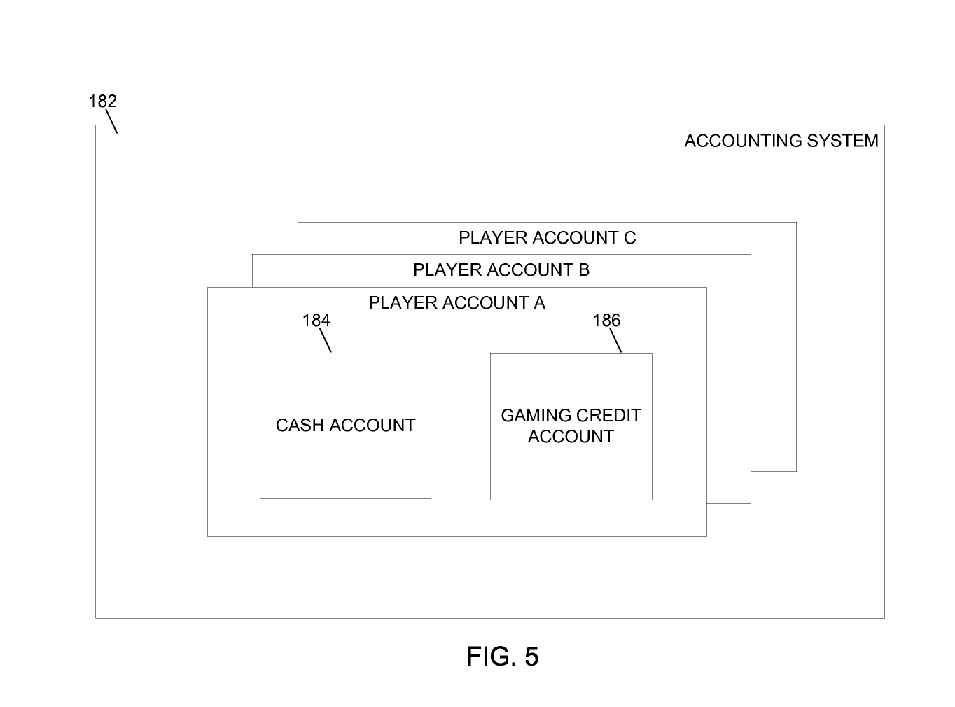

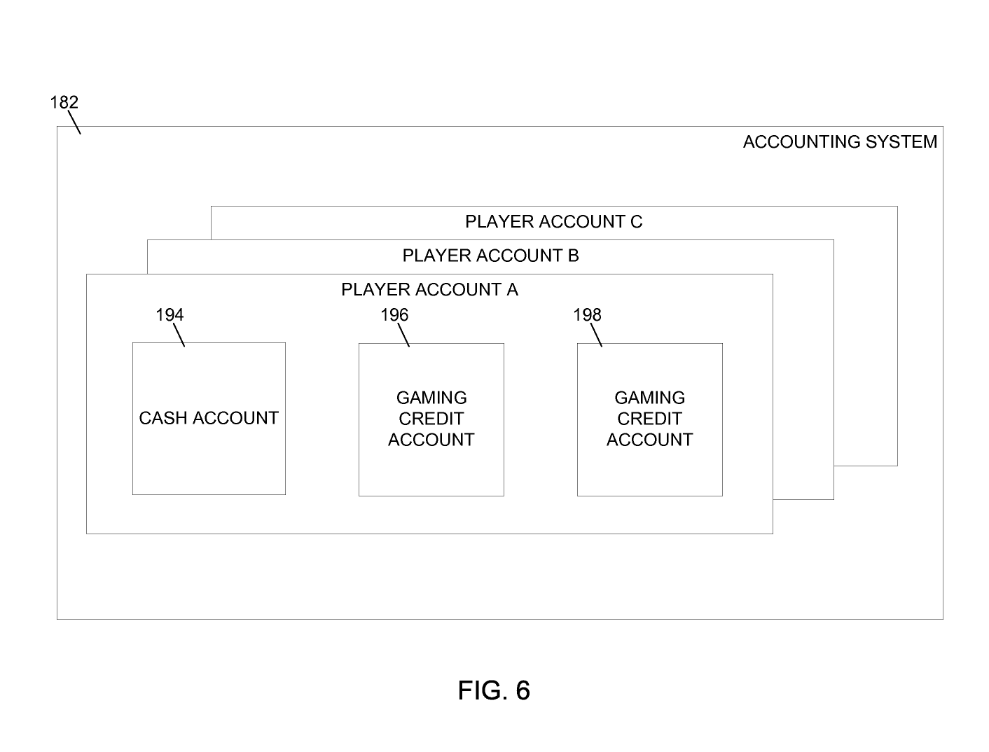

The gaming system server 166 operates in some embodiments to manage game play on the gaming devices. As one example, the gaming system server 166 includes an accounting system 182. The accounting system 182 operates to manage player accounts, for example, to keep track of wins and losses, and in some embodiments to adjust player accounts accordingly. Examples of the player accounts managed by the accounting system 182 are illustrated and described in more detail with reference to FIGS. 5 and 6.

The exemplary methods of game play described herein, including methods 100, 120, and 140 are implemented by the gaming system 160 in some embodiments. In some embodiments, one or more aspects of the methods are performed by the gaming devices 162, while in other embodiments one or more aspects of the methods are performed by the gaming system server 166. In yet other embodiments, other computing devices can be used to perform one or more of the aspects of the methods.

In another possible embodiment, the gaming system is an online gaming system, which is not separately illustrated in the Figures. As one example, the online gaming system includes a gaming system server 166 that communicates across a network 164, such as the Internet, with remote computing devices, such as player computing devices, which may be located at the player's home, for example. In some embodiments the player computing devices are mobile computing devices, such as mobile phones, tablet computers, and the like. Player computing devices access the gaming system server which operates as the gaming device to control game play according to the rules of one or more games. In some embodiments the player computing devices access the game through a web browser software application, In another possible embodiment, the player computing devices themselves operate as the gaming device using software installed locally thereon. An example of such software is a software app.

FIG. 5 is a schematic block diagram illustrating an example of the player accounts managed by the accounting system 182 of the gaming system server 166, shown in FIG. 4. In this example, the accounting system 182 is managing player accounts for three players, although any number of player accounts can be similarly managed. More specifically, the accounting system 182 includes a player account A for player A, a player account B for player B, and a player account C for player C.

In this example, the accounting system 182 manages multiple types of accounts for each player, including a cash account 184 and a gaming credit account 186.

The accounting system 182 keeps track of all transactions that occur that influence the player's cash account 184 balance. The cash account 184 is used to track all transactions that have a cash value for the player. So, for example, if the player makes a deposit with the cashier, the deposit is recorded in the player's cash account 184. In some embodiments, the cash account 184 includes or is associated with a line of credit extended by a casino, which may be guaranteed by a credit card, for example. The accounting system 182 tracks a current balance on the cash account. Typically, the player may choose to remove any remaining balance from (“cash out”) the cash account 184 in the form of cash currency at any time. Other embodiments include other cash payments from the player, and yet other embodiments include other cash payments from the casino or gaming site.

The accounting system 182 also manages the gaming credit account 186, to keep track of all transactions that occur that influence the player's gaming credit account 186 balance. The gaming credits in the gaming credit account 186 are available for game play, and can be used to place bets for game play, as described herein. The value of the gaming credits is less than the value of a corresponding quantity of cash (e.g., less than a 1:1 ratio), and in some embodiments the gaming credits have no cash value and are not redeemable for cash. In other embodiments, the gaming credits are redeemable for cash at a reduced rate, such as at a rate of 75%. In some embodiments the redemption rate is equal to or less than the payout percentage of the stage(s) of game play that would otherwise need to be played in order to convert the gaming credits into a cash value.

The example accounting system shown in FIG. 4 can be used, for example, to keep track of game play according to the method shown in FIG. 2. The cash wager 132 is deducted from the cash account 184. The winnings of the first stage 122 are added as gaming credit 134 to the gaming credit account 186. A wager placed from the gaming credits 134 is deduced from the gaming credit account 186. Winnings 136 from the second stage 124 are added to the cash account 184.

FIG. 6 a schematic block diagram illustrating another example of the player accounts managed by the accounting system 182 of the gaming system server 166, shown in FIG. 4.

Similar to the example shown in FIG. 5, the player accounts include a cash account 194 and a gaming credit account 196.

In this example, however, the player accounts each include two (or more) gaming credit accounts, including the gaming credit account 196 and a second gaming credit account 198. Multiple gaming credit accounts can be used to track gaming credits from different stages of game play, for example.

As one example, the accounting system 182 shown in FIG. 6 can be used to manage the game play shown in FIG. 3. The cash wager 152 is deducted from the cash account 194. Winnings of the first stage of game play are awarded as gaming credit 154 and added to the player's gaming credit account 196. Wagers made from the gaming credits 154 for the second stage 144 are deducted from the player's gaming credit account 196. Winnings from the second stage 144 are awarded as gaming credit 156 and added to the player's gaming credit account 198. Wagers made from the gaming credits 156 for the third stage 146 are deducted from the player's gaming credit account 198. Winnings 158 from the third stage 146 are added to the players cash account 194.

Additional gaming credit accounts are used in other embodiments to manage additional stages of game play.

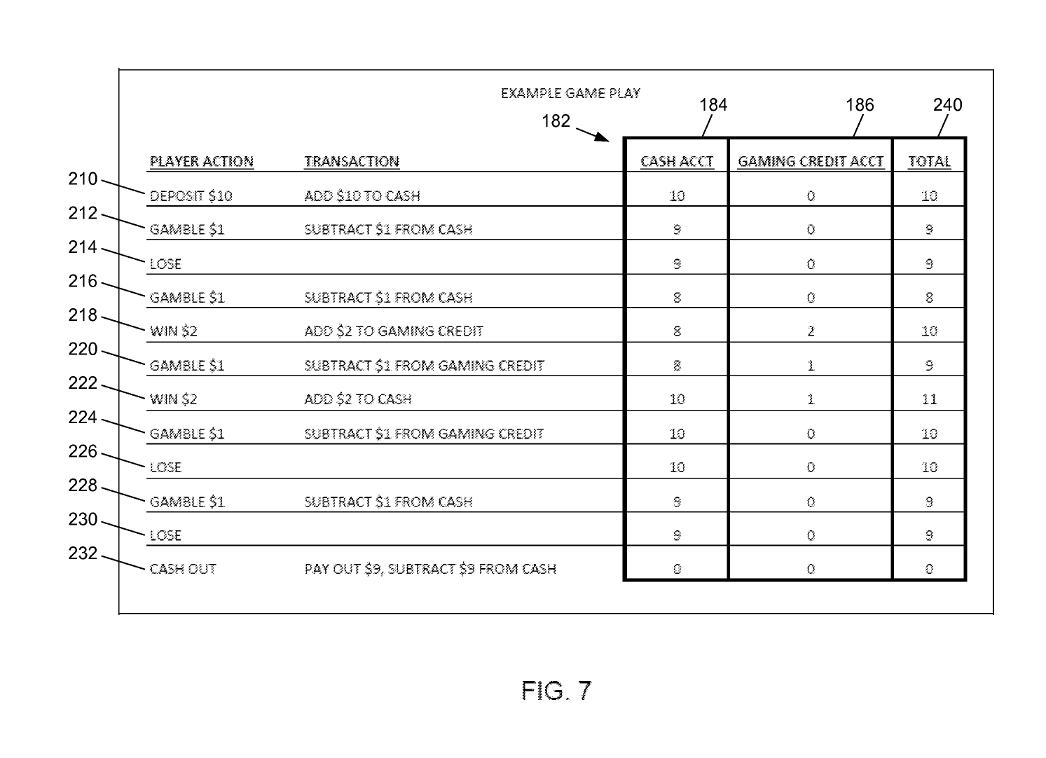

FIG. 7 is a diagram illustrating an example of game play. In some embodiments, the game play proceeds according to one or both of the methods shown in FIGS. 1 and 2, which can be implemented, for example, by the gaming system shown in FIG. 4. FIG. 7 also illustrates examples of the transactions managed by the accounting system 182 to manage a player's cash account 184 and gaming credit account 186.

In this example, game play begins with step 210 in which the player deposits $10 to his account. Upon receipt of the $10, the accounting system 182 adds $10 to the cash account 184.

The player then decides in step 212 to gamble $1, such as on a slot machine 172 (FIG. 4). Upon receipt of the bet, the accounting system 182 subtracts $1 from the player's cash account 184, resulting in a balance of $9.

The player then plays the game, and in step 214 the player loses. As a result, no further adjustments are made by the accounting system 182 in this step.

The player then bets $1 in step 216, and the accounting system subtracts $1 from the cash account 184, resulting in a balance of $8.

This time, the player wins the game in step 218, and is awarded $2. The award is paid out in gaming credits, and is added to the gaming credits account 186, resulting in a balance of $2 in gaming credits. No further adjustment is made to the cash account 184 in this step, which maintains a balance of $8.

The player bets another $1 in step 220. In this case, because the player has gaming credits available in the gaming credit account 186, the $1 is subtracted from the player's gaming credit account 186. In some embodiments, when a bet is placed, the accounting system automatically attempts to deduct the wager from the player's gaming credit account 186, before deducting any remaining amount of the wager from the player's cash account 184. In this example, because the gaming credit account 186 has a balance of $2, the $1 is subtracted from the player's gaming credit account 186, resulting in a balance of $1. No adjustment is made to the cash account, which maintains a balance of $8.

In step 222, the game is played and the player wins $2. In this case, because the game was played using a wager of gaming credits, the winnings of the game play are awarded as cash value, and the $2 is added to the player's cash account 184, resulting in a balance of $10.

Another $1 is bet in step 224, and because the gaming credit account 186 has $1, it is subtracted from the gaming credit account resulting in a balance of $0 of gaming credits.

In step 226 the player loses the game, and therefore no additional adjustments are made by the accounting system 182.

The player again gambles $1 in step 228. In this case, the player has no gaming credits remaining in the gaming credit account 186, and therefore the $1 is subtracted from the cash account 184, resulting in a balance of $8.

The player loses the game play in step 230, and no further adjustments are made.

In step 232, the player decides to cash out. As a result, the accounting system 182 subtracts the remaining balance of $9 from the cash account 184, and pays it out to the player.

In some embodiments, the transactions performed by the accounting system 182 involving the gaming credits and gaming credit account 186 are transparent to the player. For example, in some embodiments the gaming device 162 displays a total account balance 240 to the player during game play.

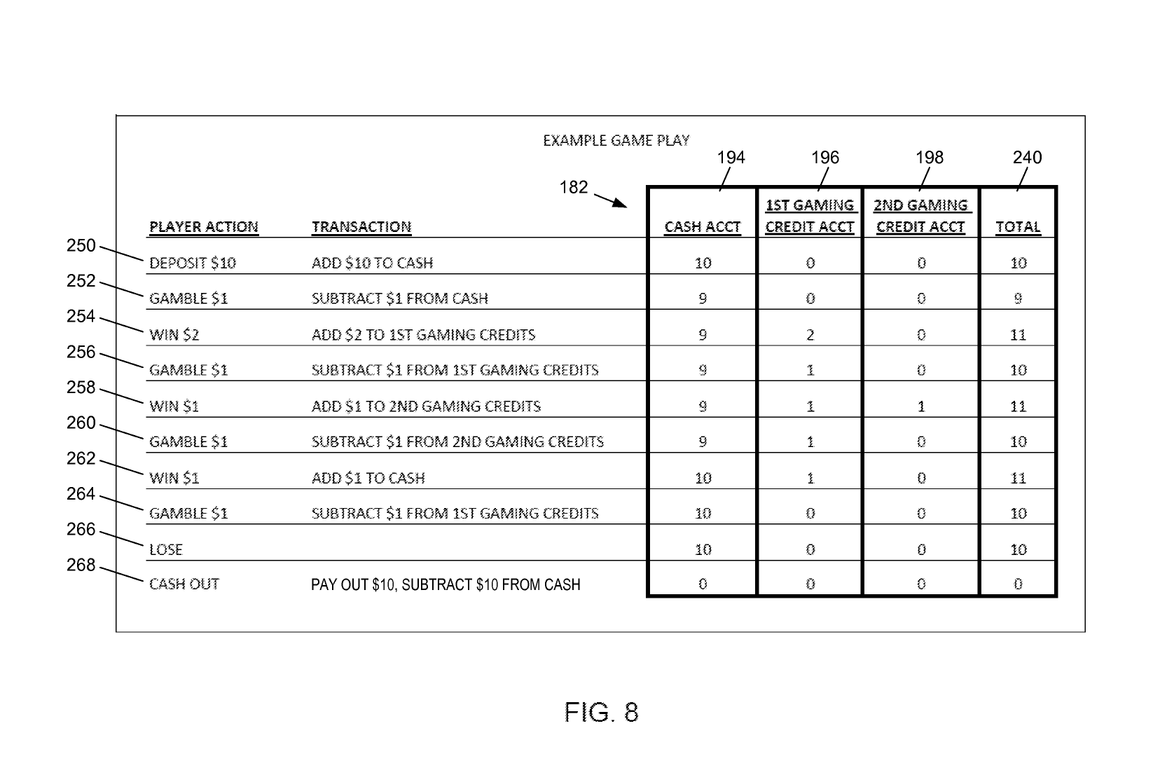

FIG. 8 is a diagram illustrating another example of game play. In some embodiments, the game play proceeds according to the method shown in FIG. 3, which can be implemented, for example, by the gaming system shown in FIG. 4. FIG. 8 also illustrates examples of the transactions managed by the accounting system 182 shown in FIG. 6 to manage a player's cash account 194 and gaming credit accounts 196 and 198.

In this example, game play begins with step 250 in which the player deposits $10. The accounting system 182 adds the $10 to the cash account 194.

The player then gambles $1 in step 252, which is deducted from the cash account 194, leaving a balance of $9.

The player wins $2 in step 254, which is awarded to the player as a first type of gaming credits. Accordingly, the accounting system 182 adds $2 to the first gaming credit account 196.

A bet of $1 is placed in step 256, and because the player has no gaming credits in the second gaming credit account 198, but has $2 in the first gaming credits, the $1 is subtracted from the first gaming credit account 196, leaving a balance of $1.

In step 258 the player wins $1. Because the $1 was won from a bet deducted from the first gaming credit account 196, the $1 is added to the second gaming credit account 198.

The player then bets another $1 in step 260. Because the player now has credits in the second gaming credit account 198, the $1 is subtracted from this account.

The player wins $1 in step 262. The $1 is awarded to the player as cash and is added to the player's cash account 194 because the $1 was won on a bet made from the second gaming credit account 198.

Step 264 involves a bet of $1. Because there are no more credits in the second gaming credit account 198, the $1 is subtracted from the first gaming credit account 196 resulting in a balance of $0 in this account.

The player loses in step 266.

The player then decides to cash out in step 268. Therefore, the remaining balance of $10 is paid to the player, and is subtracted from the cash account 194.

In some embodiments, a wager can be made from multiple accounts. For example, if in step 256 the player had instead decided to gamble $10, the wager would have been deducted by subtracting the $2 available in the first gaming credit account 196, and the remaining $8 from the cash account 194. If the player wins the game off of a split wager, the winnings are applied proportionally to the appropriate accounts. For example, 20% of the winnings in step 258 would then be added to the second gaming credit account 198, while 80% of the winnings are added to the first gaming credit account 196.

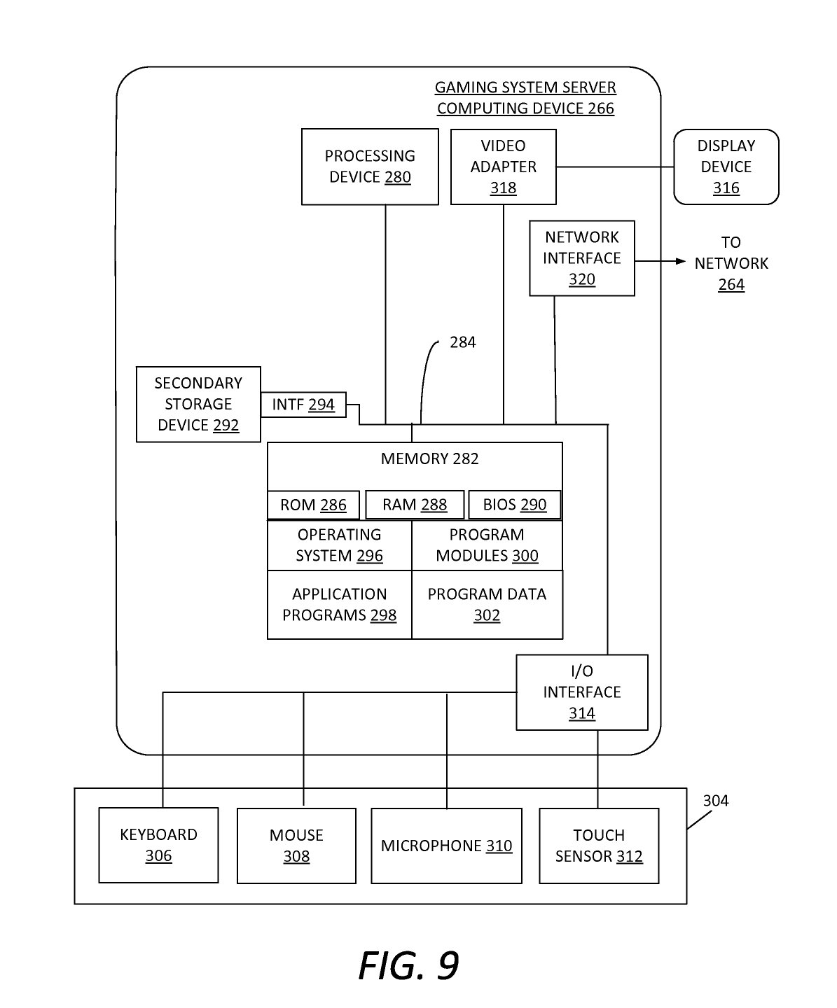

FIG. 9 illustrates an exemplary architecture of a computing device that can be used to implement aspects of the present disclosure, including the gaming system server 166, any of the gaming devices 162 (including slot machine 172, video poker game 174, and table game 176), a player computing device, or any other computing device involved in a system implemented according to the present disclosure. The computing device illustrated in FIG. 9 can be used to execute the operating system, application programs, and software modules described herein. By way of example, the computing device will be described below as the gaming system server 166 computing device. To avoid undue repetition, this description of the computing device will not be separately repeated herein for each of the other computing devices noted above, but such devices can also be configured as illustrated and described with reference to FIG. 9.

The computing device 166 includes, in some embodiments, at least one processing device 280, such as a central processing unit (CPU). A variety of processing devices are available from a variety of manufacturers, for example, Intel or Advanced Micro Devices. In this example, the computing device 166 also includes a system memory 282, and a system bus 284 that couples various system components including the system memory 282 to the processing device 280. The system bus 284 is one of any number of types of bus structures including a memory bus, or memory controller; a peripheral bus; and a local bus using any of a variety of bus architectures.

Examples of computing devices suitable for the computing device 166 include a desktop computer, a laptop computer, a tablet computer, a mobile computing device (such as a smart phone, an iPod® or iPad® mobile digital device, or other mobile devices), or other devices configured to process digital instructions.

The system memory 282 includes read only memory 286 and random access memory 288. A basic input/output system 290 containing the basic routines that act to transfer information within computing device 166, such as during start up, is typically stored in the read only memory 286.

The computing device 166 also includes a secondary storage device 292 in some embodiments, such as a hard disk drive, for storing digital data. The secondary storage device 292 is connected to the system bus 284 by a secondary storage interface 294. The secondary storage devices 292 and their associated computer readable media provide nonvolatile storage of computer readable instructions (including application programs and program modules), data structures, and other data for the computing device 166.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 292 or memory 282, including an operating system 296, one or more application programs 298, other program modules 300 (such as the software engines described herein), and program data 302. The computing device 166 can utilize any suitable operating system, such as Microsoft Windows™, Google Chrome™, Apple OS, and any other operating system suitable for a computing device.

In some embodiments, a user provides inputs to the computing device 166 through one or more input devices 304. Examples of input devices 304 include a keyboard 306, mouse 308, microphone 310, and touch sensor 312 (such as a touchpad or touch sensitive display). Other embodiments include other input devices 304. The input devices are often connected to the processing device 280 through an input/output interface 314 that is coupled to the system bus 284. These input devices 304 can be connected by any number of input/output interfaces, such as a parallel port, serial port, game port, or a universal serial bus. Wireless communication between input devices and the interface 314 is possible as well, and includes infrared, BLUETOOTH® wireless technology, 802.11 a/b/g/n, cellular, or other radio frequency communication systems in some possible embodiments.

In this example embodiment, a display device 316, such as a monitor, liquid crystal display device, projector, or touch sensitive display device, is also connected to the system bus 284 via an interface, such as a video adapter 318. In addition to the display device 316, the computing device 166 can include various other peripheral devices (not shown), such as speakers or a printer.

When used in a local area networking environment or a wide area networking environment (such as the Internet), the computing device 166 is typically connected to the network 112 through a network interface 320, such as an Ethernet interface. Other possible embodiments use other communication devices. For example, some embodiments of the computing device 166 include a modem for communicating across the network.

The computing device 166 typically includes at least some form of computer readable media. Computer readable media includes any available media that can be accessed by the computing device 166. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 166. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 9 is also an example of programmable electronics, which may include one or more such computing devices, and when multiple computing devices are included, such computing devices can be coupled together with a suitable data communication network so as to collectively perform the various functions, methods, or operations disclosed herein.

Some embodiments include one or more of the following, or combinations thereof:

A method of game play, the method comprising: playing a game; awarding winnings from the game as gaming credits; playing the game using the gaming credits; and paying out winnings from the game.

A method of game play, the method comprising: receiving a cash value wager from a player; awarding winnings from the cash value play of a game as gaming credits; receiving a gaming credit value wager from the player; and awarding winnings from the gaming credit value wager as a cash value.

A method of awarding a prize for play of a game, the method comprising: determining whether a game play wager was made with gaming credits; and when the game play wager was not made with gaming credits, awarding the prize as gaming credits.

A method of game play comprising: awarding winnings of a first stage of game play as gaming credits; using the gaming credits as a wager for a second stage of game play; and awarding winnings of the second stage of game play to the player as a cash value.

A gaming system comprising: at least one gaming device; and an accounting system, wherein the accounting system manages player accounts, the player accounts including a cash account and a gaming credits account, wherein the accounting system is operable to: when the player wins a game on the at least one gaming device on a wager from the cash account, award the winnings as gaming credits in the gaming credits account; and when the player wins a game on the at least one gaming device on a wager from the gaming credits account, award the winnings as cash in the cash account.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of game play, the method comprising:
playing a first game on one or more gaming devices;
awarding winnings from the first game as gaming credits;
playing a second game on the one or more gaming devices using the gaming credits; and
paying out winnings from the second game.

2. The method of claim 1, wherein the winnings awarded as gaming credits have no cash value and wherein the paid out winnings have a cash value.

3. The method of claim 1, wherein the winnings awarded as gaming credit and the paid out winnings both have a cash value, and wherein the cash value of the gaming credits is less per unit than the cash value of the paid out winnings per unit.

4. The method of claim 1, wherein playing the first game comprises receiving a cash value wager.

5. The method of claim 1, wherein playing a second game comprises receiving a gaming credit value wager.

6. The method of claim 1, wherein the first game and the second game are the same game played at different times.

7. The method of claim 1, wherein the first game and the second game are different games.

8. The method of claim 1, wherein playing the first game comprises deducting a wager amount from a cash account using at least one computing device of an accounting system.

9. The method of claim 1, wherein awarding winnings from the first game as gaming credits comprises increasing a value in a gaming credits account in an amount of the awarded winnings using at least one computing device of an accounting system.

10. The method of claim 1, wherein playing the second game on the one or more gaming devices using the gaming credits comprises deducting a second wager amount from a gaming credits account using at least one computing device of an accounting system.

11. The method of claim 1, wherein paying out winnings from the game comprises increasing a value in a cash account in an amount of the paid out winnings using at least one computing device of an accounting system.

12. The method of claim 1, wherein playing the first game on the one or more gaming devices comprises using gaming credits from a first gaming credit account from one or more prior stages of game play on the one or more gaming devices, and wherein awarding winnings from the first game as gaming credits comprises increasing a value of a second gaming credits account in an amount of the awarded winnings.

13. A gaming system comprising:
at least one gaming device; and
an accounting system including at least one computing device, wherein the accounting system manages player accounts, the player accounts including a cash account and a gaming credits account, wherein the accounting system is operable to:
when the player wins a game on the at least one gaming device on a wager from the cash account, award the winnings as gaming credits in the gaming credits account; and
when the player wins a game on the at least one gaming device on a wager from the gaming credits account, award the winnings as cash in the cash account.

14. The gaming system of claim 13, wherein the at least one gaming device has a first stage of game play in which winnings are awarded as gaming credits, and a second stage of game play in which winnings are paid out as cash value.

15. The gaming system of claim 14, wherein a payout percentage of game play including the first stage and the second stage of game play is less than a payout percentage of the first stage of game play and is less than a payout percentage of the second stage of game play.

16. The gaming system of claim 15, wherein the accounting system is further operable to pay to a player a cash value at a reduced rate based on the gaming credits, wherein the reduced rate is less than or equal to a payout percentage of the second stage of game play.

17. The gaming system of claim 13, wherein the at least one gaming device is selected from the group consisting of a slot machine, a video poker game, and a table game.

18. The gaming system of claim 13, wherein the at least one gaming device is a gaming system server that communicates with a player computing device across a network, and wherein the game is an online game.

19. A method of game play comprising:
awarding winnings of a first stage of game play as gaming credits using a computing device;
using the gaming credits as a wager for a second stage of game play; and
awarding winnings of the second stage of game play to the player as a cash value using the computing device.

20. The method of claim 19, wherein the first stage of game play and the second stage of game play are played on one or more gaming devices.
